(19) United States
(12) Patent Application Publication
(10) Pub. No.: US 2005/0177498 A1
(43) Pub. Date: Aug. 11, 2005

(54) Providing visualization of market offers using a multi-dimensional display including geometrically shaped icons

(75) Inventor: Noel Tenorio, Mountain View, CA (US)

Correspondence Address: James E. Walton;i2 Technologies US, Inc., One i2 Place, 11701 Luna Road, Dallas, TX, 75234, US

(73) Assignee: i2 TECHNOLOGIES US, INC.

(21) Appl. No.: 11/105,109

(22) Filed: Apr. 13, 2005

Related U.S. Application Data
(63) Continuation of application No. 09/970,377, filed on Oct. 2, 2001.

(51) Int. Cl. G06F 17/60

(52) U.S. Cl. 705/39

(57) ABSTRACT

A method of providing visualization of market offers includes receiving offer data for multiple offers, the received offer data reflecting values specified in the offers for multiple offer variables. The method further includes generating a display of the received offer data. The display comprising multiple dimensions each corresponding to an offer variable and defining a range of values of the corresponding offer variable. The dimensions define a multi-dimensional space, each position within the multi-dimensional space corresponding to a set of values of the offer variables. The display also includes multiple geometrically-shaped icons, each icon representing an offer and being positioned with respect to the dimensions of the display according to the values of the offer variables for the offer. The different positions of the offers within the display allow a user to readily visually compare the offers in connection with a market decision.

### TECHNICAL FIELD OF THE INVENTION

This invention relates generally to electronic commerce and more particularly to providing visualization of market offers using a multi-dimensional display that includes geometrically shaped icons.

### BACKGROUND OF THE INVENTION

Business transactions are increasingly taking place over the Internet and other electronic communication networks. Electronic markets may provide a forum for such transactions, allowing buyers to locate sellers, and vice versa. This process may involve a buyer (or seller) identifying one or more suitable offers to sell (or buy) from one or more sellers (or buyers). However, it may be difficult for a buyer (or seller) to identify suitable offers to sell (or buy) from among the offers available to the buyer (or seller) for a number of reasons. For example, there may be a relatively large amount of information for a buyer (or seller) to consider when trying to identify suitable offers to sell. The market may include a relatively large number of offers. Offers may include a number of variables, and there may be a relatively large number of possible values for each variable. Additionally, there may be no available offers providing a substantial match with a particular order from the buyer (or seller). The buyer (or seller) may therefore have to determine which of the available offers provide a relatively close match with that order, taking into account a number of offer variables and possibly the relative priorities of such variables.

### SUMMARY OF THE INVENTION

According to the present invention, disadvantages and problems associated with previous techniques for displaying market data may be substantially reduced or eliminated.

According to one embodiment of the present invention, a method of providing visualization of market offers includes receiving offer data for multiple offers, the received offer data reflecting values specified in the offers for multiple offer variables. The method further includes generating a display of the received offer data. The display comprising multiple dimensions each corresponding to an offer variable and defining a range of values of the corresponding offer variable. The dimensions define a multi-dimensional space, each position within the multi-dimensional space corresponding to a set of values of the offer variables. The display also includes multiple geometrically-shaped icons, each icon representing an offer and being positioned with respect to the dimensions of the display according to the values of the offer variables for the offer. The different positions of the offers within the display allow a user to readily visually compare the offers in connection with a market decision.

Particular embodiments of the present invention may provide one or more technical advantages. For example, certain embodiments may provide visualization of multiple offers each including multiple offer variables using a multi-dimensional display of geometrically shaped icons. Use of such icons within a multi-dimensional display may allow a user to more readily identify suitable offers from among multiple existing offers in an electronic market, through comparison of the shape and location within the display of a reference icon, representing the needs of the user as specified in a query or other user request, with the shapes and locations of icons representing existing offers. This may be especially true where there are a relatively large number of offers and a relatively large number of possible values for each variable, such that distinguishing between these offers would be very difficult using previous techniques. Thus, the present invention may allow a user to more easily determine which of the available offers provide a relatively close match with the query or other user request. Certain embodiments may allow a user to more readily take into account a number of offer variables and possibly the relative priorities of such variables when making such a determination. Particular embodiments may incorporate one or more approved seller (or buyer) lists into a visualization of offers, which may allow a user to more easily identify suitable offers from among a number of offers in an electronic market considering such lists. Certain embodiments may highlight for a user one or more costs associated with excluding one or more sellers (or buyers), such as a resulting average price increase (or decrease). The present invention may help to increase the efficiency and effectiveness with which a user interacts with a computer system that supports an electronic market and improve the ability of the user to make informed and successful market decisions.

Systems and methods incorporating one or more of these or other technical advantages may be well suited for modern electronic markets. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for providing visualization of market offers using a multi-dimensional display including geometrically-shaped icons;

FIG. 2 illustrates an example multi-dimensional display that incorporates geometrically-shaped icons to provide visualization of market offers;

FIG. 3 illustrates an example aspect of the multi-dimensional display of FIG. 2;

FIG. 4 further illustrates an example aspect of the multi-dimensional display of FIG. 2; and

FIG. 5 illustrates an example method for providing visualization of market offers using a multi-dimensional display including geometrically-shaped icons.

### DETAILED DESCRIPTION OF EXAMPLE EMBODIMENTS

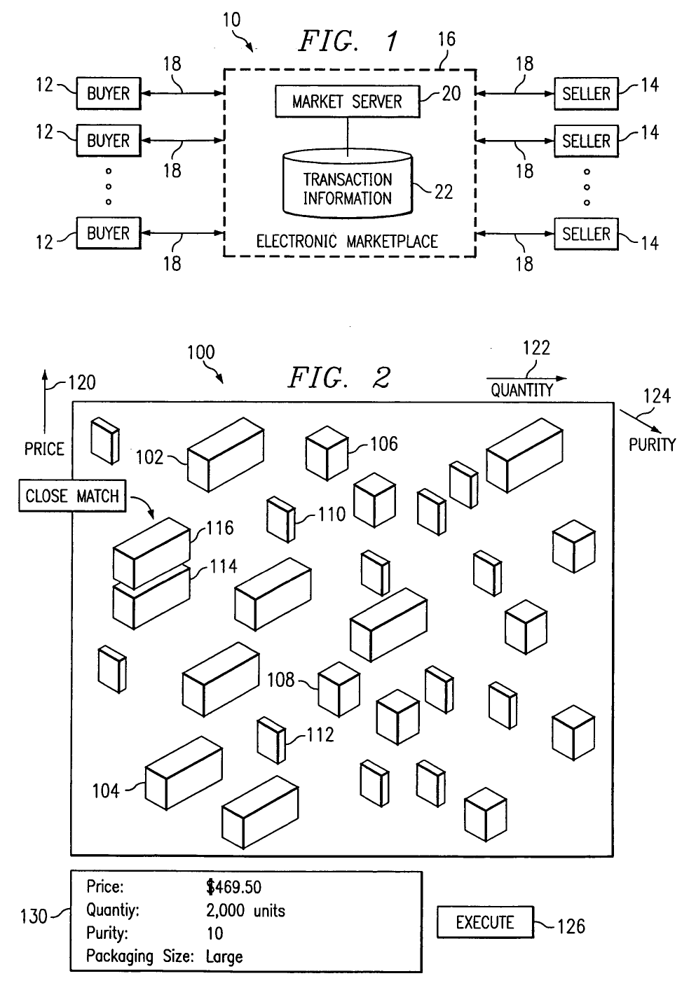

FIG. 1 illustrates an example system 10 for providing visualization of market offers using a multi-dimensional display that includes geometrically-shaped icons. System 10 may include one or more buyers 12, one or more sellers 14, and at least one electronic marketplace 16 associated with a web site or other environment accessible to buyers 12 and sellers 14. In general, electronic marketplace 16 may receive bids from buyers 12 and asks from sellers 14, match bids and asks where appropriate, and initiate transactions between buyers 12 and sellers 14 where appropriate. Electronic marketplace 16 may receive a query in connection with the discovery phase of an electronic commerce transaction and may thereafter search one or more databases to return search results responsive to these query. A bid may be matched with an ask, for example, where the corresponding bid price is greater than or substantially equal to the corresponding ask price, and matching a bid with an ask may result in a transaction being initiated between the correspond buyer 12 and seller 14. A bid may include an offer to buy, and an ask may include an offer to sell. Such offers may include a number of variables, and each offer may specify a value for one or more of these variables. For example, a bid may specify a bid price, a bid quantity, a delivery time, and values for any other suitable variables. The present invention contemplates any suitable offers with any suitable variables. Reference to an “offer” may include a bid, an ask, or either, where appropriate.

Although certain example markets are described herein, the present invention contemplates any suitable market including one or more offers from one or more buyers 12 and one or more sellers 14. For example, the present invention may provide visualization of a number of offers in an auction-based market, an exchange-based market, a Request for Comment (RFQ)-based market, or any other suitable market. Additionally, the present invention may provide visualization of a number of offers in a market that is part of a larger market including a number of associated markets. Although buyers 12 and sellers 14 are described as separate entities, a buyer 12 in one transaction may be a seller 14 in another transaction, and vice versa. Moreover, reference to a “buyer” or a “seller” may include a person, a computer system having one or more computers, an enterprise, or any other buying or selling entity, as appropriate. For example, a buyer 12 may include a computer programmed to autonomously identify a need for an item, search for that item, and buy that item upon identifying a suitable seller. Although buying and selling are described herein, the present invention contemplates any appropriate market transaction. Items may include raw materials, component parts, products, or any other tangible or intangible things that may be the subject of a transaction between a buyer 12 and a seller 14, and a single item may include one or more other items. Additionally, items may include lots, blocks, bundles, bushels, or other suitable units of one or more individual items, where appropriate. For example, capacitors may be bought and sold in indivisible units of five hundred capacitors, instead of one capacitor at a time.

Buyers 12, sellers 14, and electronic marketplace 16 may be coupled to each other using links 18 that may each include one or more local area networks (LANs), metropolitan area networks (MANs), wide area networks (WANs), a portion of the Internet, or any other appropriate wireline, optical, wireless, or other links. The components of electronic marketplace 16 may operate on one or more computers at one or more locations, and electronic marketplace 16 may share one or more computers or other resources with one or more buyers 12 or one or more sellers 14, according to particular needs. Bids and asks may be received by the electronic marketplace 16 or an associated device in any suitable format, such as in the form of Hypertext Markup Language (HTML), Extensible Markup Language (XML), or other suitable files within Hypertext Transport Protocol (HTTP) messages.

Associated with electronic marketplace 16 may be one or more market servers 20 and one or more databases containing transaction information 22. In general, market server 20 may support a particular electronic market for a particular item. For example, market server 20 may receive bids from buyers 12 and asks from sellers 14, prioritize bids and asks, match bids with asks where appropriate, initiate transactions between buyers 12 and sellers 14 where appropriate, cancel or otherwise remove from the market a bid or ask (automatically or at the request of the corresponding buyer 12 or seller 14), keep a record of initiated transactions by storing associated transaction information 22, and perform other appropriate tasks associated with supporting an electronic market. In addition, market server 20 may perform tasks associated with generating a display providing visualization of a number of offers including a number of offer variables. For example, market server 20 may communicate data reflecting offers in the market to one or more buyers 12, sellers 14, or other suitable entities, which data may be used by the recipients to generate displays providing visualization of the offers. Transaction information 22 may include a number of records, each corresponding to a particular initiated transaction. A record of an initiated transaction may reflect one or more transaction terms, which may be the terms of the accepted offer. Such terms may include a transaction price, a transaction quantity, and other suitable transaction terms. Transaction information 22 may be used by buyer 12, seller 14, and any other appropriate entities to finalize a transaction between buyer 12 and seller 14 initiated as the result of a strike or for any other suitable purposes.

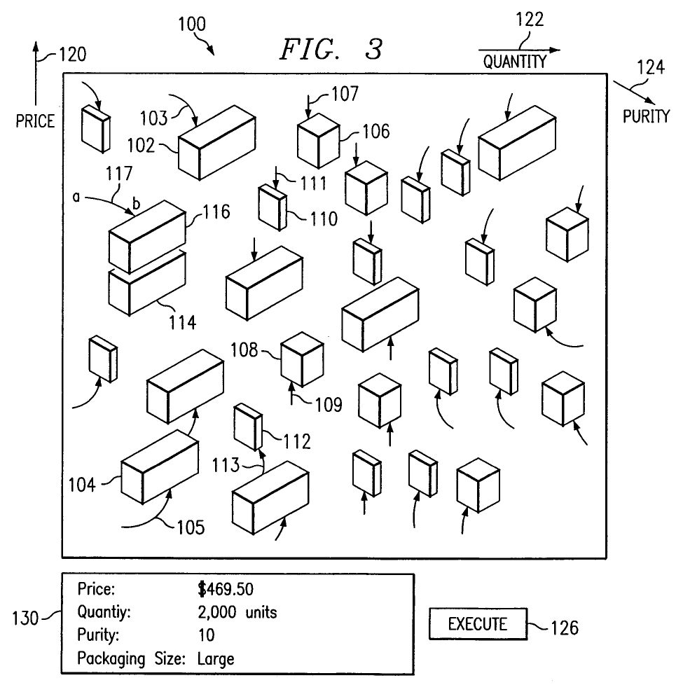

FIG. 2 illustrates an example multi-dimensional display 100 including geometrically-shaped icons to provide visualization of market offers. Display 100 may be generated in any suitable manner for use by any suitable entities. In one embodiment, for example, market server 20 may communicate data reflecting values specified in a number of offers to a computer system associated with a buyer 12, which computer system may, using the communicated data, generate display 100 for the exclusive use of buyer 12. In another embodiment, for example, market server 20 may locally generate all or certain portions of display 100 for a buyer 12 and communicate corresponding display data to a computer system associated with buyer 12 for the exclusive use of buyer 12. In another embodiment, for example, market server 20 may locally generate certain portions of display 100 for use by any number of buyers 12 and communicate corresponding display data to a computer system associated with a particular buyer 12, which computer system may modify display 100 (which may include generating further portions of display 100) for buyer 12. Although display 100 is described as being generated for and used by a buyer 12, the present invention contemplates display 100 being generated for any suitable entity for any suitable purpose. Display 100 may be updated as changes in offers occur (which may include new offers being made, existing offers being modified, offers being removed from the market, and possibly other changes) to provide a substantially real-time visualization of offers in the market. Display 100 may provide visualization of any suitable offers in any suitable market. For example, display 100 may provide visualization of bids, asks, or both in an exchange-based market.

Display 100 includes a number of geometrically-shaped icons 102, 104, 106, etc. each representing a corresponding offer. Preferably, icons 102, 104, 106, etc. are six-sided polyhedrons (particular sides of which may not be viewable depending on the orientation) resembling blocks. However, icons 102, 104, 106, etc. may have any suitable shapes according to particular needs. The placement of icons 102, 104, 106, etc. within display 100 corresponds to the values of offer variables for the associated offers, each offer variable corresponding to a particular dimension of display 100. The appearances of icons 102, 104, 106, etc., along with their positions in display 100, preferably enable a user to readily visualize and compare among the different offers being represented. By comparing the appearances and locations of icons 102, 104, 106, etc., the user is preferably able to readily identify which of the offers are suitable for its needs and which offers are not, without needing to conduct a detailed evaluation of the actual values associated with the offers as in previous techniques. This may be especially useful where display 100 includes a large number of icons 102, 104, 106, etc. for a large number of offers. Furthermore, an important aspect of certain embodiments of the present invention may be to provide a multi-dimensional display 100 that allows the user to readily visualize and interpret substantially real-time market data reflecting changes within a dynamic market environment, which may enable the user to more efficiently and effectively plan, make, and execute on market decisions.

In one embodiment, for example, per item or other prices for quantities of items for market offers associated with icons 102, 104, 106, etc. may be graphically represented by the locations of icons 102, 104, 106, etc. with respect to a price axis 120. Also, for example, shading, color, shape, text, or other indicia may be used to distinguish between bids and asks, where both types of offers are included in display 100. For example, lighter-shade icons (e.g., 104, 108, 112, etc.) associated with generally lower prices may represent bids, while darker-shade icons (e.g., 102, 106, 110, etc.) associated with generally higher prices may represent asks. Quantities of items for offers associated with icons 102, 104, 106, etc. may be represented by the locations of icons 102, 104, 106, etc. with respect to a quantity axis 122. The display 100 may include one or more additional dimensions, for example, a purity dimension (as illustrated in FIG. 2) having an associated purity axis 124. In this case, the purity values for offers may be represented by the locations of icons 102, 104, 106, etc. with respect to purity axis 124. Other appropriate dimensions may replace or combine with the dimensions described above, and the present invention is intended to encompass any suitable combination of two or more dimensions, whether or not such dimensions are illustrated or described herein. In particular, although display 100 is illustrated and primarily described as having three dimensions, display 100 may have any appropriate number of dimensions (e.g., two dimensions) according to particular needs.

In one embodiment, icons 102, 104, 106, etc. may be used to represent the package sizes of associated offers. For example, icons 102 and 104 may represent large packages sizes for the associated offers, icons 106 and 108 may represent medium package sizes for the associated offers, and icons 110 and 112 may represent small package sizes for the associated offers, according to a predetermined scale for package sizes. As used herein, the “package size” for an offer represents the quantity of items that may be exchanged in a single transaction or as a single unit of sale (e.g., box, pallet, etc.). For example, an icon may reflect a large package size, indicating that at least one thousand items can be bought (for an ask icon such as icon 102) or sold (for a bid icon such as icon 104) in a single transaction or as a single unit from the seller 14 (for an ask icon) or by the buyer 12 (for a bid icon). Similarly, an icon may reflect a medium package size, indicating that between one hundred and one thousand items can be bought or sold in a single transaction or as a single unit, or a small package size, indicating that no more than one hundred items can be bought or sold in a single transaction or as a single unit. The above are merely examples; any suitable package sizes or no package sizes may be reflected by icons 102, 104, 106, etc. of display 100 according to particular needs. Furthermore, instead of or in addition to package sizes for offers being represented by associated icons 102, 104, 106, etc. with different sizes as shown, different package sizes may be distinguished using icons 102, 104, 106, etc. having different shapes, colors, or any other suitable properties.

Any suitable offers may be included within or excluded from display 100 according to particular needs. For example, if a buyer 12 is using display 100, the ask icons for sellers 14 not listed on an approved vendor list (AVL) for buyer 12 can be excluded from display 100 or, alternatively, included within display 100 but made visually distinguishable from ask icons for sellers 14 listed on the AVL. By including icons representing offers from excluded market participants within display 100, the effects of excluding the market participants may be highlighted to the user, which effects may include there being fewer options available to a buyer 12 or seller 14 seeking to identify suitable offers and thus higher or lower prices, respectively. A market participant may be excluded from an approved market participant list for any suitable reason. For example, a buyer 12 may exclude from an AVL all sellers 14 not within a certain geographical area. Approved market participant lists for a particular entity may vary from item to item. For example, an AVL for a first item for a buyer 12 may include a particular seller 14, while an AVL for a second item for that buyer 12 may exclude that seller 14. As another example of excluding certain offers from display 100, display 100 may exclude bid icons (e.g., 104, 108, 112, etc.) and include only ask icons (e.g., 102, 106, 110, etc.), thereby providing a display of market data only for the ask side of the market. Alternatively, display 100 may exclude ask icons and include only bid icons, thereby providing a display of market data only for the bid side of the market. The present invention contemplates any suitable offers being excluded from display 100 in response to user input, automatically according to a user profile or the nature of the market, or in any other manner. Possibly in combination with text, a visually distinguishing aspect of an icon 102, 104, 106, etc. may identify the market participant that made the associated offer. An approved market participant list may be accessed in any appropriate manner. For example, an approved market participant list may be stored in a database accessible to a computer system that supports display 100, which may access the list before generating the display 100 to determine which market participants are approved and which are not.

In addition to icons 102, 104, 106, etc. representing offers, display 100 may include one or more request icons (e.g., icon 114) representing associated queries or other user requests. A request may include values for one or more offer variables and may represent an ideal offer matching one or more preferences for the user. For example, buyer 12 may enter a value for one or more variables corresponding to the dimensions of display 100. The entered values may each match buyer preferences for these variables, and an icon 114 representing the entered request may be generated within display 100, allowing the buyer 12 to compare the request represented by icon 114 with asks represented by ask icons 102, 106, 110, etc. Allowing the user to make such a comparison may allow the user to more readily identify one or more offers providing a “best fit” match with the request. For example, the user may determine that the offer represented by icon 116 provides the best fit match with the request represented by icon 114 among the available offers. More specifically, the user may determine that the offer represented by icon 116 provides the best fit match among available offers in that the offer represented by icon 116 provides a large package size along with a relatively close fit as to price, quantity, and purity. Thus, the present invention may be particularly useful in connection with proximity, as opposed to exact match or identicality, searching.

Display 100 may allow a user to visually compare an icon (e.g., icon 102) representing an existing offer from that market participant with icons 106, 110, etc. representing existing offers on the same side of the market (e.g., the bid side where the participant is a buyer 12), based on their appearances and locations within display 100. According to the comparison the user may elect to modify its offer to be more competitive with other existing offers, to make it more likely that market server 20 will match its offer with one or more offers on the other side of the market or to otherwise reflect its market strategy. In one embodiment, the user may be allowed to click on or otherwise select the icon corresponding to its offer, drag or otherwise move the icon to the appropriate location within display 100 reflecting its modified offer, and then click on or otherwise select execute icon 126 to re-enter the offer as now modified according to the new location of its icon within display 100. Window 130 may display information that changes in substantially real time as the icon moves within display 100 to provide a substantially accurate display of the values associated with the icon at all times. This features may be employed whether the icon being moved represents an offer or a query or other user request.

Display 100 may also include execution icon 126, which may facilitate order entry. A user may select execution icon 38 to cause an order to be automatically generated based on information displayed within window 130 or elsewhere within display 100 and communicated to market server 20. Any suitable combination of hardware and software supporting display 100 may operate to generate an order and communicate it to market server 20. Where an order communicated to market server 20 substantially matches an available offer, market server 20 may match the order with one or more appropriate offers upon receiving the order. Where an order communicated to market server 20 does not substantially match an available offer, market server 20 may hold the order until an offer substantially matching the order is received. Where the order can be considered an offer, that offer may, if not matched, be included within a display 100 accessible to other users, such as, for example, sellers 14 where the offer is submitted on behalf of a buyer 12.

Information for generating an order may be entered in any suitable manner. As described above, for example, a user may enter one or more values for variables. An icon 114 representing the entered request may be generated within display 100, which may allow the user to compare the request with one or more offers to identify one or more offers providing a best fit match with the request. The user may select execution icon 38 to cause an order to be generated based on the entered request and communicated to market server 20. Alternatively, the user may first modify one or more entered values such that the request on which the order is based sufficiently matches an offer represented by an icon (e.g., icon 116) within the display 100. In addition or as an alternative to manually entering values, a user may select an icon (e.g., icon 116) within display 100 and then select execution icon 126, which may cause an order to be generated with the values specified in the offer represented by the selected icon and communicated to market server 20 for execution.

Orders generated in response to a user selecting execution icon 38 may specify one or more particular market participants for any suitable reason, such as preventing the order from being matched with an offer from an unapproved market participant. One or more market participants may be individually specified by a user, for example, and those market participants may in turn be specified in the order that is generated and communicated to market server 20. As another example, the user may simply indicate that the order may be matched only with an approved market participant. The order generated and communicated to market server 20 may in turn specify those market participants which are approved (which may be determined from an approved market participant list, as described above). As another example, the user may select a particular icon (e.g., icon 116) within display 100 to cause the values specified in the associated offer to be displayed within window 130. An order that is generated for communication to market server 20 in response to the user subsequently selecting execution icon 38 may specify the particular market participant that has made the offer represented by the selected icon.

Although display 100 is primarily described with reference to a market that includes a number of offers from sellers 14, the present invention contemplates any suitable information being represented within display 100. For example, a user may enter a parametric query for data for items matching one or more criteria. The query may be communicated to one or more databases containing data for a number of items, possibly from a number of different sellers 14. Data for items matching the criteria returned in response to the query may be represented within display 100 such that each icon 102, 106, 110, etc. represents values for attributes of a particular item. Such data for a particular item may constitute an offer from an associated seller 14 as that term is used herein.

FIG. 3 illustrates an example aspect of the multi-dimensional display of FIG. 2. In one embodiment, the locations of icons 102, 104, 106, etc. may be continuously or incrementally updated in substantially real-time, allowing a user to more readily visualize changing market conditions as they evolve over time, which provide improved decision support in a dynamic market environment. For example, as shown in FIG. 3, in addition to icons 102, 104, 106, etc., display 100 may include arrows 105, 107, 109, etc. that depict the behavior of associated icons 102, 104, 106, etc. over time. Referring to icon 116 as an illustrative example, arrow 117 represents a movement of icon 116 from location “a” to location “b” during a certain interval of time. In this regard, where display 100 is three-dimensional for example, arrow 117 can represent a three-dimensional vector (i.e. representing movement of icon 116 at a certain rate and in a certain direction in the price, quantity, purity space of example display 100). By viewing display 100 illustrated in FIG. 3, a user is preferably able to readily and intuitively determine how and the extent to which the market conditions have changed and can be expected to change as existing offers are matched with other offers, canceled, or otherwise removed from the market, as new offers are added to the market, and as existing offers that are not removed from the market migrate through display 100.

Although not shown in FIG. 3, one or more of the arrows 105, 107, 109, etc. within display 100 can include information indicating historical and/or current prices, quantities, purities, or any other suitable values, or other information such as identities of the market participants, for associated market offers. For example, by clicking on, brushing over, or otherwise selecting the arrow 117, a user might cause price, quantity, and purity information associated with icon 116 to be displayed in a pop-up window (not shown) in proximity to arrow 117. Information associated with an arrow may be different depending on the portion or particular point along the arrow that is selected (e.g., the information displayed for location “a” of arrow 117 may be different than the information displayed for location “b” of arrow 117). A user may enter a new offer such that the associated icon is within the trajectory of an icon for an existing offer (e.g., an existing ask where the new offer is a bid), as reflected by the associated arrow, such that the new offer is likely to be matched with the existing offer as the existing offer continues to migrate over time according to its trajectory.

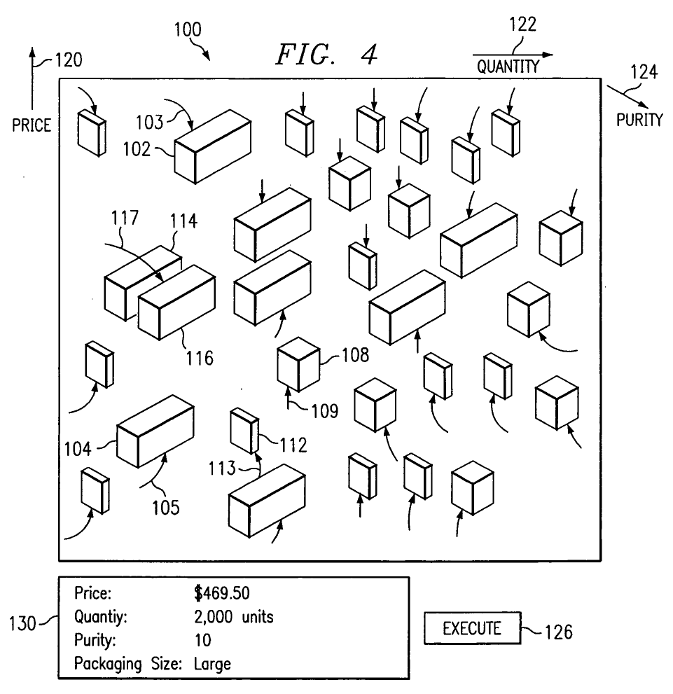

FIG. 4 further illustrates an example aspect of display 100 of FIG. 2. As shown for this example of display 100, certain icons in display 100 have migrated over time with respect to price, quantity, and/or purity, reflecting the dynamic nature of the market. Similarly, certain icons have disappeared (e.g., due to the associated offers having been matched with other market offers or otherwise removed from the market), and certain new icons have appeared (e.g., due to associated offers having been newly entered).

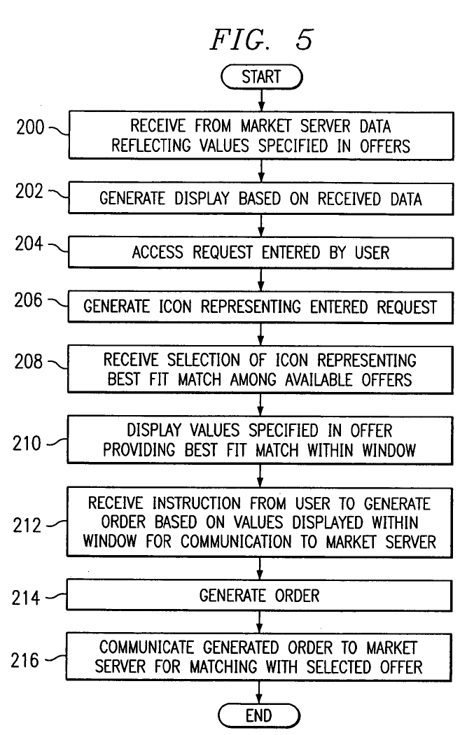

FIG. 5 illustrates an example method of providing visualization of market offers using a multi-dimensional display including geometrically-shaped icons. The method begins at step 200, where a computer system associated with a buyer 12 receives data reflecting values specified in market offers. As described above, the data may be received from a market server 20 supporting the market. Although display 100 is described as being generated for a buyer 12, the present invention contemplates display 100 being generated for any suitable entities (which may include buyers 12, sellers 14, or both) for any suitable purpose, as described above. Although display 100 is described as being locally generated using data received from a market server 20, display 100 may be generated in any suitable manner, as described above. At step 202, the computer system generates display 100 based on the received data. As described above, display 100 may include icons 102, 106, 110, etc. representing offers and associated values of offer variables. At step 204, the computer system accesses a query or other request entered by a user. The request may include a value for every offer variable represented by dimensions of display 100. At step 206, the computer system generates icon 114 within the display 100 representing the entered request. This may, as described above, allow the user to readily identify upon visual inspection a best fit match from among the available offers, particularly where the number of offers or offer variables is relatively large.

At step 208, the computer system receives from the user a selection of the pattern 104 representing the offer that provides the best fit match with the entered request from among the available offers. At step 210, the computer system may display the values specified in the offer providing the best fit match using a suitable window within display 100 (not shown), which may involve changing any values already displayed within the window to match the values of the offer providing the best fit match. At step 212, the computer system receives an instruction to generate an order based on the values for the selected offer for communication to market server 20. As described above, the user may provide an order the instruction by selecting execution icon 126. At step 214, the computer system generates an order based on values for the selected offer. As described above, the generated order may specify values being displayed within a window of display 100 (not shown). At step 216, the computer system communicates the generated order to market server 20 for matching with the selected offer, and the method ends.

Although the present invention has been described with several embodiments, a plethora of changes, substitutions, variations, alterations, and modifications may be suggested to one skilled in the art, and it is intended that the invention may encompass all such changes, substitutions, variations, alterations, and modifications fall within the spirit and scope of the appended claims.

1. A system for providing visualization of market offers, comprising a computer system operable to:
receive offer data for a plurality of offers, the received offer data reflecting values specified in the offers for a plurality of offer variables; and
generate a display of the received offer data, the display comprising:
a plurality of dimensions each corresponding to one of the offer variables for which values are specified in the offers and comprising a range of values of that offer variable, the dimensions defining a multi-dimensional space, each position within the multi-dimensional space uniquely corresponding to a set of values of the offer variables for which values are specified in the offers; and
a plurality of geometrically-shaped icons, each icon representing one of the offers and being positioned with respect to the dimensions of the display according to the values of the offer variables specified in that offer, the different positions of the offers within the display allowing a user to readily visually compare the offers in connection with a market decision.

2. The system of claim 1, wherein each geometrically-shaped icon is sized to represent a package size for the associated offer, the package size indicating a quantity of items that may be exchanged in a single transaction or as a single unit for the associated offer.

3. The system of claim 1, wherein the display comprises a plurality of arrows each associated with one of the geometrically-shaped icons and representing the movement of the geometrically-shaped icon from a first position within the display to a second position within the display over a time interval.

4. The system of claim 1, wherein the computer system is operable to update the positions of the icons within the display in substantially real time as market conditions change.

5. The system of claim 1, wherein the user is a buyer and the offers comprise ask icons only from sellers on an approved vendor list (AVL).

6. The system of claim 1, wherein the display is three-dimensional and the offer variables for which values are specified in the offers and corresponding to the dimensions comprise price, quantity, and at least one additional offer variable for which values are specified in the offers.

7. The system of claim 1, wherein the geometrically-shaped icons are polyhedrons.

8. The system of claim 1, wherein the computer system is operable to:
access a user request, the request comprising a plurality of entered values for a plurality of offer variables; and
generate within the display a geometrically-shaped icon representing the user request, the icon for the request being positioned with respect to the dimensions of the display according to the entered values of the offer variables for the request, such that the user may compare the icon for the user request with the icons for one or more offers in connection with a market decision.

9. The system of claim 8, wherein the computer system is operable to:
receive a selection of a particular icon associated with a particular offer;
receive an instruction to generate an order based on the values for the offer associated with the selected icon;
in response to receiving the instruction, automatically generate an order based on the values for the offer associated with the selected icon; and
communicate the generated order for matching with the selected offer.

10. The system of claim 9, wherein the computer system is operable to display the values specified in the user request and the values specified in the offer associated with the selected icon to allow the user to compare these values before providing an instruction to generate an order.

11. A method of providing visualization of market offers, comprising:
receiving offer data for a plurality of offers, the received offer data reflecting values specified in the offers for a plurality of offer variables; and
generating a display of the received offer data, the display comprising:
a plurality of dimensions each corresponding to one of the offer variables for which values are specified in the offers and comprising a range of values of that offer variable, the dimensions defining a multi-dimensional space, each position within the multi-dimensional space uniquely corresponding to a set of values of the offer variables for which values are specified in the offers; and
a plurality of geometrically-shaped icons, each icon representing one of the offers and being positioned with respect to the dimensions of the display according to the values of the offer variables specified in that offer, the different positions of the offers within the display allowing a user to readily visually compare the offers in connection with a market decision.

12. The method of claim 11, wherein each geometrically-shaped icon is sized to represent a package size for the associated offer, the package size indicating a quantity of items that may be exchanged in a single transaction or as a single unit for the associated offer.

13. The method of claim 11, wherein the display comprises a plurality of arrows each associated with one of the geometrically-shaped icons and representing the movement of the geometrically-shaped icon from a first position within the display to a second position within the display over a time interval.

14. The method of claim 11, further comprising updating the positions of the icons within the display in substantially real time as market conditions change.

15. The method of claim 11, wherein the user is a buyer and the offers comprise ask icons only from sellers on an approved vendor list (AVL).

16. The method of claim 11, wherein the display is three-dimensional and the offer variables for which values are specified in the offers and corresponding to the dimensions comprise price, quantity, and at least one additional offer variable for which values are specified in the offers.

17. The method of claim 11, wherein the geometrically-shaped icons are polyhedrons.

18. The method of claim 11, further comprising:
accessing a user request, the request comprising a plurality of entered values for a plurality of offer variables; and
generating within the display a geometrically-shaped icon representing the user request, the icon for the request being positioned with respect to the dimensions of the display according to the entered values of the offer variables for the request, such that the user may compare the icon for the user request with the icons for one or more offers in connection with a market decision.

19. The method of claim 18, further comprising:
receiving a selection of a particular icon associated with a particular offer;
receiving an instruction to generate an order based on the values for the offer associated with the selected icon;
in response to receiving the instruction, automatically generating an order based on the values for the offer associated with the selected icon; and
communicating the generated order for matching with the selected offer.

20. The method of claim 19, further comprising displaying the values specified in the user request and the values specified in the, offer associated with the selected icon to allow the user to compare these values before providing an instruction to generate an order.

21-32. (canceled)
